(19) United States
(12) Patent Application Publication
(10) Pub. No.: US 2002/0075816 A1
(43) Pub. Date: Jun. 20, 2002

(54) Wireless transceivers using a simplified Prism II system

(76) Inventor: Robert W. Beckwith, Clearwater, FL (US)

Correspondence Address: Leo J. Aubel, 111 Rivershire Lane, Lincolnshire, IL, 60069, US

(21) Appl. No.: 09/997,102

(22) Filed: Nov. 28, 2001

Related U.S. Application Data
(60) Provisional application No. 60/255,046, filed on Dec. 12, 2000.

(51) Int. Cl. H04B 7/005

(52) U.S. Cl. 370/278

(57) ABSTRACT

Inventive wireless transceivers implement only peer to peer communications and otherwise are non-compliant with IEEE Std. 802.11 thereby eliminating complexity and costs and providing improved performance.

### REFERENCES

1. Intersil Corporation Application Note AN9829: “Brief Tutorial on IEEE 802.11 Wireless LANs”.

2. IEEE standard 802.11.

3. U.S. Pat. No. 5,943,202 “TWO WAY PACKET RADIO INCLUDING SMART DATA BUFFER AND PACKET RATE CONVERSION” by Robert W. Beckwith, the inventor herein.

4. U.S. Pat. No. 5,646,512 “MULTIFUNCTION ADAPTIVE CONTROLS FOR TAPSWITCHES AND CAPACITORS” BY Robert W. Beckwith.

5. U.S. patent application Ser. No. 09/479605 “EXPANDED CAPABILITIES FOR WIRELESS TWO-WAY PACKET COMMUNICATIONS FOR IEDs” filed by Robert W. Beckwith on Jan. 8, 2000.

6. Instruction manual for the SEL-2020 Communications Processor available from Schweitzer Engineering Laboratories, Inc. located in Pullman, Wash. This is a typical prior art wired hub.

### SUMMARY OF THE INVENTION

In a partial use of IEEE STD 802.11, a MINIMAC replaces the standard MAC (Media Access Controller) used in an Intersil Prism II wireless system so as to only provide peer to peer communications between wireless modules. The devices based on the present invention are capable of establishing a wireless connection which is transparent to the structure of protocol communications over the connection. The built in tolerance of the Prism II Base Band Processor mitigates data crashes without requiring the cumbersome Ethernet structure of the full IEEE STD 802.11.

The foregoing features and advantages of the present invention will be apparent from the following more particular description of the invention. The accompanying drawings, listed herein below, are useful in explaining the invention.

### BRIEF DESCRIPTION OF THE DRAWINGS

FIG. 1 shows “FIGURE 1 PEER TO PEER COMMUNICATIONS IN AD HOC NETWORK” from Reference 1 Note AN9829 defining peer to peer wireless communications as used herein;

FIG. 2 illustrates inventive relations of a modified basic service set (BSS) to a Distribution System i.e., a LAN;

FIG. 3a shows a diagram of a hypothetical wireless transceiver circuit compliant with IEEE Std 802.11 for comparison with the inventive wireless transceiver of FIG. 3b;

FIG. 3b shows a diagram of a wireless transceiver circuit with an inventive MINIMAC providing peer to peer communications between pairs of transceivers;

FIG. 4a shows an Intelligent Electronic Device (IED) with a hypothetical wireless transceiver that meets requirements for IEEE Std 802.11; note the comparison with an IED using a wireless transceiver shown in FIG. 4b which is in accordance with the present invention;

FIG. 4b shows an IED using an inventive wireless transceiver providing peer to peer communications between pairs of IEDs;

FIG. 5 shows an isometric view of an inventive wireless transceiver;

FIG. 6 shows an isometric drawing of an inventive wireless transceiver for inserting in a PCMCIA port of a computer; and

FIG. 7 shows, in accordance with the invention, an RS232 to wireless converter for converting wired IEDs for use with wireless hubs.

### DESCRIPTION OF THE PREFERRED EMBODIMENTS

U.S. Pat. No. 5,943,202 “TWO WAY PACKET RADIO INCLUDING SMART DATA BUFFER AND PACKET RATE CONVERSION” is issued to Robert W. Beckwith, the inventor herein. This patent gives basic principles for wireless communications between an enclosed area such as an electric utility substation and an end use point outside of the enclosure.

U.S. Pat. No. 5,646,512 “MULTIFUNCTION ADAPTIVE CONTROLS FOR TAPSWITCHES AND CAPACITORS” also issued to Robert W. Beckwith. Under the discussion related to FIG. 23 of the patent '512, it is stated, “Alternatively communications is provided by way of a plug in wireless modem 902 using PCMCIA receptacle 900”. This feature is discussed further herein below in the discussion of the use of Internet.”

U.S. patent application Ser. No. 09/479605 “EXPANDED CAPABILITIES FOR WIRELESS TWO-WAY PACKET COMMUNICATIONS FOR IEDs” was filed by Robert W. Beckwith on Jan. 8, 2000. This relates to structures for wireless hubs.

The above referenced two patents together with referenced patent application, as well as the present invention, describe a wireless communications system useable for protection and control of electric power systems. While such electric power systems are used herein for illustrations of the present invention other applications include manufacturing plants, shopping malls and facilities where it is desirable to replace wired communication networks with wireless networks.

This invention provides the “radio” referred to in U.S. Pat. No. 5,943,202. Note that the term “wireless” is generally used herein in place of the term “radio” as being more descriptive of the related technology.

While U.S. Pat. Nos. 5,943,202 and 5,646,512, above, describe concepts of wireless communications, the present invention provides inventive devices and methods for their use in carrying out said concepts.

Reference 1 Application Note AN9829 describes operation of the Intersil Prism II system at 2.4 GHz in the ISM band. This is a band within which operation is permitted without individual station licensing.

The Prism II system utilizes Direct Sequenced Spread Spectrum (DSSS) technology as described in more detail in the Application Note AN9829 which is included herein as a reference. The system provides point to point communications of binary data streams with a series of communication attempts in anticipation of a number of reasons for failure of a particular try. This includes the occasion of a data crash and retries at randomly assigned time delays, thus avoiding data crashes.

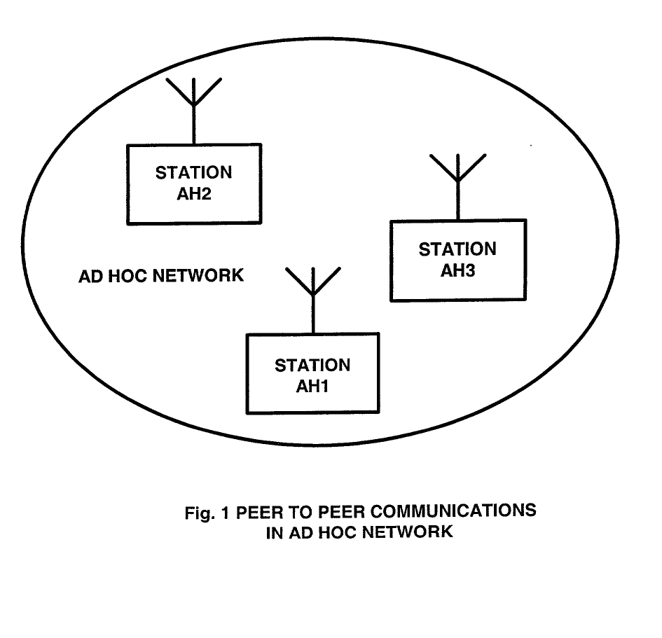

FIG. 1 relates to FIG. 1 of Reference 1, an Intersil Corporation Application Note AN9829 titled: “Brief Tutorial on IEEE 802.11 Wireless LANS”. FIG. 1 of Note An9829 defines an ad hoc network of peer to peer wireless communications as used herein.

In an electric utility substation, stations generally labeled 1 are often termed IEDs (Intelligent Electronic Devices).

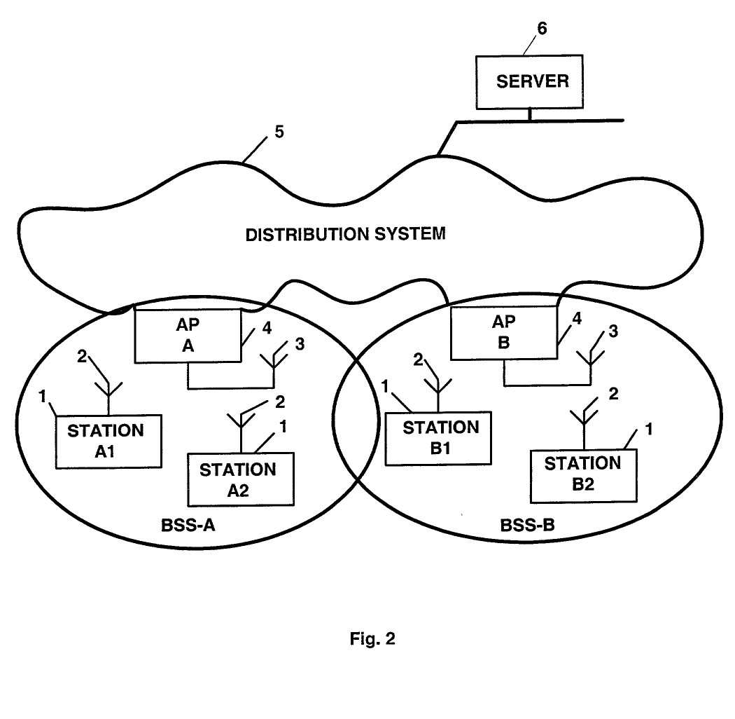

FIG. 2 relates to FIG. 2 of Intersil Note AN9829. Note that Distribution System 5 is a Local Area Network (LAN) using Ethernet for preventing data crashes on physical communications paths as required for non-wireless networks. FIG. 2 illustrates the inventive use of peer to peer communications not only between stations, generally labeled 1, but also from stations 1 to access port 4 to avoid the need for Ethernet at levels below access port 4.

A server 6 initiates and receives messages which must be sent through a land based distribution system 5 of physical communication paths. In this non-wireless or “land based” distribution system Ethernet technology is used to manage the transmission of information so as to avoid data crashes on any of the paths used.

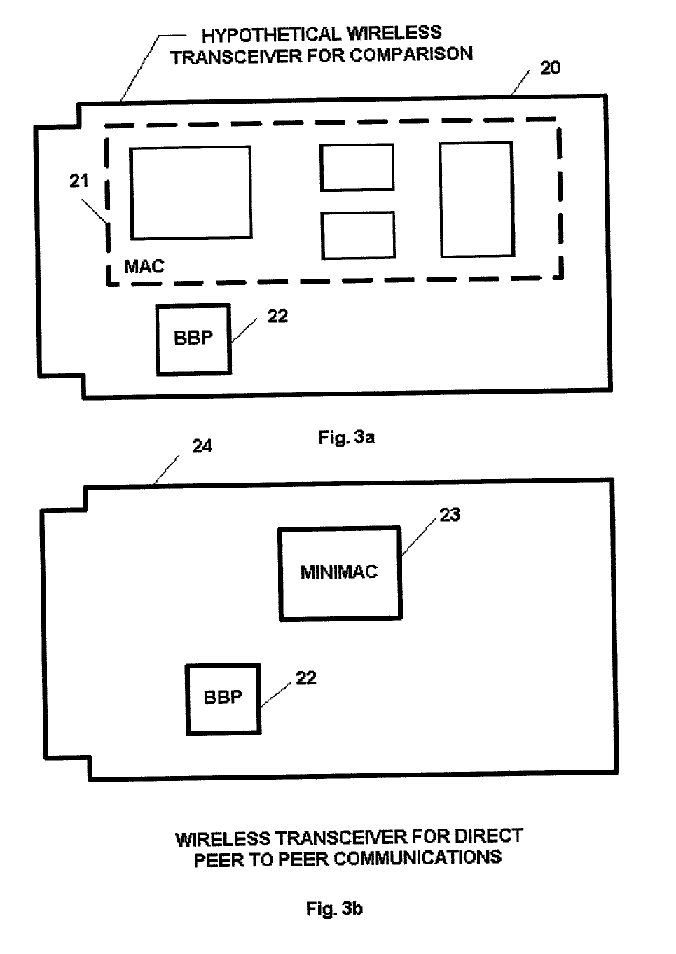

Access Port (AP), generally labeled 4, use a wireless transceiver with antenna 3 such as described in FIG. 3b, inventively extending peer to peer communications from stations, generally labeled as 1, to the access port. Because of the nature of the wireless media, AP 4 becomes a wireless hub sending messages from antenna 3 which reach all antennae 2 of wireless transceivers on stations 1, i.e.,the IEDs. U.S. patent application Ser. No. 09/479605 cited above as reference number 5, describes such a wireless hub in detail. A Beckwith Electric Co. Model M-2850 wireless hub, based on said U.S. patent application Ser. No. 09/479605, also provides protocol conversion between those devices served by wireless transceivers and those used by non-wireless land based communications points.

Peer to peer messages are supported between stations 1 (the IEDs) and from stations 1 to a wireless hub creating the possibility of data crashes. The Prism II chip set, however, has the capability of avoiding data crashes thus eliminating the need for Ethernet at levels below the wireless hub.

Simple coding systems are used in wireless transceivers to select communications paths between 256 stations within BSSs. Use is made of 8 bit codes to select communications between up to 256 stations. Each wireless transceiver uses one of the 8 bit codes as an identity. A calling station can then use any of up to 255 other codes to select a station to receive a call. A second 8 bits is included in the message to identify the calling station. Selectively codes of other length are used for groups of more and less than 256 total stations.

To accomplish this method of calling, the MINIMAC program includes the following steps:

1. send the 8 bit code of a station to be called,

2. include the 8 bit code identifying the calling station,

3. wait for the station called to respond with its 8 bit identity code confirming receipt of the messages of steps 1 and 2,

4. the calling station then sends a message packet.

Note that this process is identical when used between a station and a hub as when used between two stations in direct peer to peer communications. This establishes a direct “pipeline” path from the hub to an IED through which the hub can address the IED, directly in the protocol in which it operates, as if the hub were temporarily connected to the IED by wire. (Pipeline is defined as a communications channel whose protocol is invisible to those using the channel.) Similarly any two IEDs can communicate directly with each other as peers regardless of their protocol so long as they are identical to each other.

Note that the local area networks BSS-A and BSS-B are essentially identical. The BSSs are generally far enough apart that wireless stations in one BSS are unable to interfere with wireless stations in any other BSS in the use of coding described above for selection of paths between stations.

FIG. 3a illustrates a hypothetical printed circuit board 20 fully supporting IEEE Ethernet Specification 802.11. Media Access Control (MAC) 21 controls Basic Band Processor (BBP) 22. Note, now the inventive circuitry of FIG. 3b which shows a reduction of three sets of chips as compared with FIG. 3a.

FIG. 3b illustrates the printed circuit board 24 used in a Beckwith Electric Model M-2910 wireless transceiver. The full MAC 21 of FIG. 3a is replaced by an inventive MINIMAC chip 23 which implements ad hoc peer to peer communications in accordance with FIG. 1. Board 24 uses selected chips from the Prism II chip set which include the Base Band Processor (BBP) chip 22.

The BBP chip 22 manages the detection of data crashes. When a crash is detected, a data packet is transmitted again with a random delay in time greatly reducing the probability of a second data crash. Multipath distortion is a phenomena not found in land based networks. It is mitigated in BBP 22 by repeating the transmission using a different selection of spread spectrum signals. Many transmissions are used in steps, correcting reasons for unsuccessful transmissions as they occur, until a successful transmission is achieved. The net result provides a one megabit per second average data rate through high levels of electromagnetic noise as compared to systems not using DSSS coding.

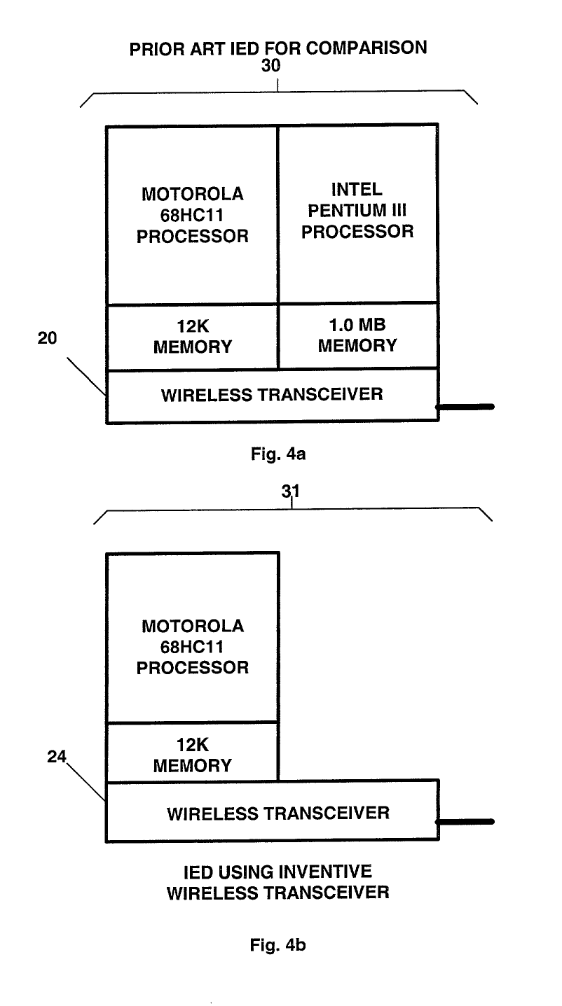

FIG. 4a illustrates an IED 30 fully supporting IEEE standard 802.11 and using the hypothetical wireless transceiver 20 circuitry of FIG. 3a. Such a terminal is capable of 1.0 megabit per second data rates the same as IED 31 of FIG. 4b. IED 31 of FIG. 4b uses the inventive wireless transceiver 24 of FIG. 3b. The comparison of FIG. 4a and FIG. 4b illustrates a principal advantage of the present invention in the savings of the cost of a microprocessor such as the Pentium III in substation IEDs. Such an IED is shown in FIG. 4a together with supporting 1.0 MB memory.

The inventive MINIMAC 23 in wireless transceiver 24 of FIG. 4b provides pipeline wireless communications paths. Transceiver 24 includes the simple coding required for path selection. The resulting pipeline paths between transceivers 24 can be considered the same as momentary wires in the design of systems using the inventive transceivers 24.

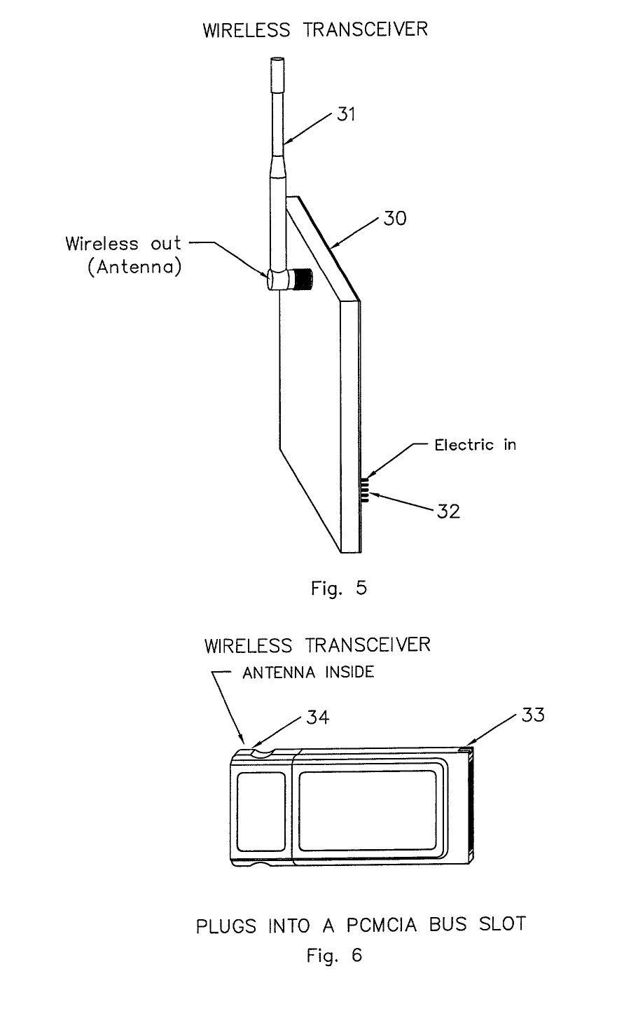

FIG. 5 is an isometric view of a Beckwith Electric Co. Model M-2910 wireless transceiver 30 using the principles of the present invention. These devices communicate electric digital information signals from an “electric in” port 32 and provide signals to and from “wireless out” antenna 31.

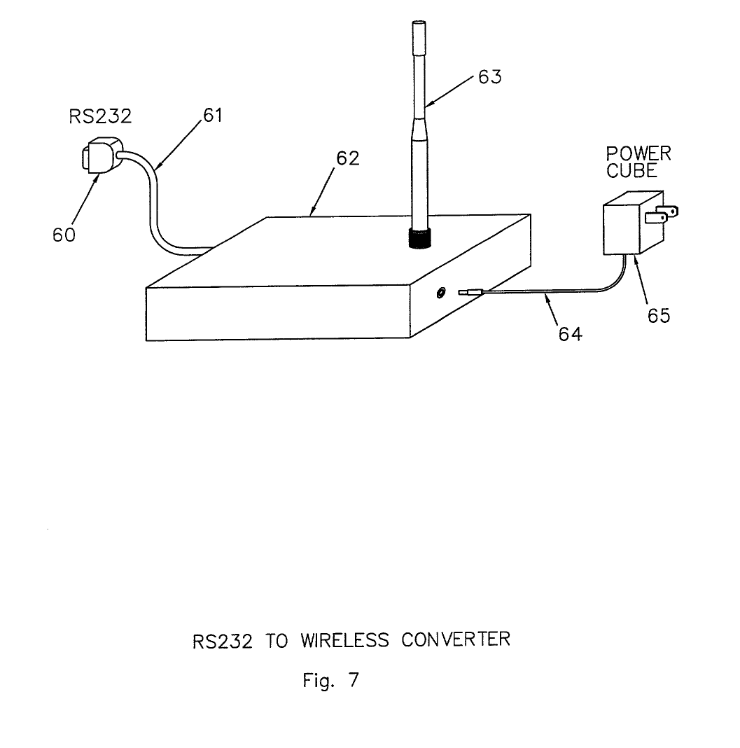

FIG. 6 is an isometric view of a Beckwith Electric Co. M-2912 device 33 using the principles of the invention. The M-2912, when inserted in PCMCIA slots of laptop or other computers, permits communications to the computers as well as with the M-2910 device 30 of FIG. 5, to the wireless converter 62 of FIG. 7, and to the M-2950 wireless hub. An antenna 34 is located inside of a portion of the end of device 33 which protrudes approximately ½ outside of the PCMCIA slot into which it is inserted. Device 33 makes a parallel bus connection with the computer into which it is inserted supporting megabit per second communications to and from most computers.

FIG. 7 illustrates a Beckwith Electric M-2911 including an RS232 to wireless converter 62. This is intended for use in converting existing IEDs operating into a wired hub (such as the hub described in reference 5) and to ones operating into the M-2950 wireless hub.

FIG. 7 shows RS232 connector 60 connected by cable 61 into wireless converter 62 with wireless output from antenna 63. Converter 62 is typically powered through connector 64 by power cube 65 to be used with a standard electrical socket, not shown.

### Advantages of the Invention as Applied to Electric Substations

1—Low cost wireless modules.

2—Lower cost IEDs using the inventive wireless devices.

3—High speed direct peer to peer communications between IEDs.

4—Provides for wireless hubs with wireless connections from hub to IEDs that are transparent to protocol communications using the connections.

5—Ease of conversion of existing IEDs to use with wireless hubs.

6—Simple high speed wireless communications between computers using existing programs provided in most computers for wire connections. The unnecessary burden of adding Ethernet is avoided when not communicating over external land-line networks.

7—Simple wireless communications between computers and other devices having inventive wireless transducers.

While the invention has been particularly shown and described with reference to preferred embodiments thereof, it will be understood by those skilled in the art that various changes in form and details may be made therein without departing from the spirit and scope of the invention.

I claim:

1. A method of utilizing modified Intersil Prism II chip sets in wireless transceivers consisting of the step of replacing Media Access Control (MAC) chips in said chip sets with Miniature Media Access Controller (MINIMAC) chips so as to provide two way ad hoc peer to peer communications between said wireless transceivers.

2. A method as in claim 1 consisting of the further steps of:
a) adding said wireless transceivers to Intelligent Electronic Devices (IEDs); and
b) communicating directly from IEDs to IEDs.

3. A method as in claim 1 consisting of the further step of using wireless transceivers with modified Prism II chip sets at hubs for two way communications with said wireless transceivers which are providing peer to peer communications.

4. A method as in claim 1 consisting of the further step of:
a) using binary codes to identify wireless transceivers; and
b) communicating between first wireless transceivers identified by one of said binary codes and wireless transceivers identified by other of said binary codes.

5. A method as in claim 3 consisting of the further steps of:
a) adding communications from said hub to said wireless transceivers which are providing peer to peer communications;
b) connecting said wireless transceivers which are providing peer to peer communications to IEDs; and
c) sending and receiving digital information without change in said IED protocol from that in use before said addition of communications,
whereby the use of Ethernet at the IED level is unnecessary.

6. A method as in claim 3 including the further step of communicating from said hub to said station using the protocol of said station.

7. A method as in claim 1 including the further steps of:
a) using said wireless transceivers in devices for use in PCMCIA receptacles;
b) placing said devices for use in PCMCIA receptacles of computers; and
c) communicating by wireless between said computers.

8. A method as in claim 5 including the further step of communicating from said computers to said IEDs.

9. A method as in claim 3 including the further step of communicating from said computers to said hub.

10. A method as in claim 7 including the further step of communicating from said computers to said IEDs.

11. A method as in claim 7 including the further step of communicating from said computers to said hub.

12. Wireless transceiver devices, said devices comprising in combination: a) an Intersil Prism II base band processor chip;
b) a modified Intersil Prism II miniature media access controller (MINIMAC) chip;
c) program means for said MINIMAC chip implementing ad hoc peer to peer communications between said wireless transceiver devices;
d) electrical input connectors for bidirectional digital data; and
e) antennae for wireless signals.

13. Devices as in claim 12 further comprising in combination:
a) MINIMAC chip program means for storing an 8 bit identity code for a first said device;
b) MINIMAC chip program means for storing an 8 bit identity code in as many as 255 other said devices using one of the 255 unused 8 bit binary codes for each identity;
c) MINIMAC chip program means whereby said first device can initiate a two way wireless transmission using the 8 bit binary assigned to a device for its selection; and
d) MINIMAC chip program means in said first device to include said first devices' 8 bit binary identity code in said wireless transmission.

14. Devices as in claim 12 further comprising MINIMAC chip program means for answering a wireless transmission by using said first devices' 8 bit identity code included in the message received.

15. Devices as in claim 13 further comprising in combination:
a) device construction means for inserting in PCMCIA ports of computers;
b) device constructions means including said antenna for wireless signals; and
c) MINIMAC chip program means for converting messages to and from parallel bus PCMCIA connections to and from serial messages for two way wireless transmission using said antenna.

16. Devices as in claim 12 further comprising in combination:
a) connector means whereby said electrical input connectors connect to existing electric utility substation Intelligent Electronic Devices (IEDs); and
b) MINIMAC chip programs which provide for two way digital communications between said IEDs and said wireless transceiver devices.

17. Devices as in claim 13 further comprising in combination the use of other than 8 bit codes for identifying more and less than a total of 256 stations.
